(19) United States
(12) Patent Application Publication
(10) Pub. No.: US 2009/0045278 A1
(43) Pub. Date: Feb. 19, 2009

(54) Crushing element and mills with grinding bodies, mixers, extruders and a pressing worm provided with said crushing elements

(76) Inventor: Ulrich Bech, Dornbirn (AT)

Correspondence Address: Frank W. Compagni;Morriss O'Bryant Compagni, 734 East 200 South, Salt Lake City, UT, 84102, US

(21) Appl. No.: 11/666,178

(22) PCT Filed: Oct. 21, 2005
(86) PCT No.: PCT/IB05/03146

§ 371 Date: Apr. 22, 2008

(30) Foreign Application Priority Data
Oct. 21, 2004 (CH) 01739/04

(51) Int. Cl. B02C 7/12

(52) U.S. Cl. 241/297

(57) ABSTRACT

The invention relates to a ground element for mills, mixers and worms used preferably for the grinding/processing of paper stock and plastics materials comprising ceramic fillings, other fibrous substances such as crude brown coal, beet chip and the like. The ground elements have at least two fastening elements, which can have undercuts (44), beads and/or corners, on the fastening side (36) opposing the working surface (38) for fastening the ground element (41) in corresponding holes in a support body. Ground elements of this type can be arranged on the rotors of high-speed refiners. Rotors of this type have annular sectors which can be composed of a large number of individual ground elements. Differing tasks can, in this case, be assigned to the individual annular sectors. A central sector is formed from securely embedded metal carbides which have high thermal stability and which have emergency running properties if the ground discs are scraped. As a result of the provision of a slightly smaller working gap in the region of this sector, the adjacent sectors are protected from scraping and can be formed by modularly constructed, cost-effective ground elements (lamellar bodies) made of ceramics or pressed carbon fibres. As a result of precise large-scale production by powder injection moulding (PIM) and pressing into a screen-like carrier plate, these lamellar bodies can be produced for any user as desired, with optimum geometry. Exchange is simple and rapid.

### SUBJECT-MATTER OF THE INVENTION

The present invention relates to a ground element, for example for mills, mixers, extruders and pressure worms.

### PRIOR ART

Mills and mixers are constructed, one behind another, in large numbers and with various ground plates for differing end substances and various intermediates. Usually, the ground plates on the ground disc are made of a permanent mould casting alloy to which chromium carbides impart sufficient hardness to meet the requirements placed on wear. With conventional machines and in the processing of pure wood fibre material at average speeds, this results in a satisfactory mode of operation with revision intervals of six to ten months. The quality of the ground-up fibres is markedly co-determined by the ribbed geometry of the ground plates which ensure a helical flow of material via the ribs up to the outlet. A pumping or pressing effect is thus obtained. It is crucial to achieve this effect in pressure worms and extruders. At the same time, an intimate, uniform through-mixing of the introduced substance is achieved in all cases, as the substance is of heterogeneous composition.

The manufacture of fine paper requires grinding to very small fibre diameters and lengths. This requires a small working gap in the order of magnitude of a few tenths of a millimetre. In practice, use is made of mill works which operate with rollers, cones or ground discs. In the case of ground discs, in which the material flows radially from the inside toward the outside, the relatively high circumferential velocities cause wear to take place predominantly in the outer third. However, the inner portions of the ground disc, which hardly wear at all, are crucial for the distance between the ground discs of the rotor and stator, so adjusting the shaft cannot compensate for material wear in the outer sectors of the ground disc: on adjustment of the shaft, there is a risk that the ground plates will be scraped. This risk is particularly high when starting up and shutting down the machine, when the pressure and material flow conditions are not yet stable.

For economical and ecological reasons, there is increasing demand to incorporate into the mixture of substances existing substances and material reclaimed from production. This frequently requires ceramic-type fillers also to be processed, and this markedly increases wear. To solve this problem, use is often made of relatively hard ground bodies. However, these are extremely sensitive to slight scraping. If the ground bodies in the outer working edge region are worn even slightly by a few tenths of a millimetre, an excessively large working gap is produced in the most important working region for the grinding of the fibres and substance mixtures. The output of the machine drops, as does the quality of the product. Extremely precise adjustments, capable of rapid response, can improve utilisation of the ground discs up to the geometric limit.

In the case of high-speed machines with internal pressure, the working gaps are so small as to be in the range of the resilient reactions of the machine: the smallest of changes in the vibrational behaviour of the mill work caused by changes in the material properties can therefore bring about intensive wear to the ground discs or even the destruction of the machine.

Procedurally, it is possible to boost the daily output of the machines by minimising the width of the working gap and increasing the rotational speed using advanced control means and regulator circuits. It is possible to increase the grinding output while at the same time reducing power consumption by as much as 20%. The cost of this is the need frequently to change the ground discs, as peak outputs are achieved only in a short phase of the service life. Conventional ground discs consist of a carrier and lamellar-type ground bodies which are made of permanent mould casting and arranged on the carrier. The production of the permanent mould casting ground bodies requires mass abrasion of the lamellar surface prior to integration. However, this results in sharp working edges which do not allow optimum grinding results at the start of the grinding process. Optimum grinding results are achieved only after a ‘run-in phase’ (edge rounding). If increased wear is accepted, the grinding output and product quality fall rapidly.

### OBJECT OF THE INVENTION

The object of the present invention is to propose a ground element having a longer service life. A further aim is to propose a ground body comprising a ground element which supplies the desired grinding quality from the outset. A further aim is to propose a roller, cone or ground disc mill work which can be produced cost-effectively and has a long service life. A further aim is to provide machines, in particular grinding devices such as refiners for paper, extruders for plastics material and ceramics, pressure worms for wet fibrous substances, brown coal, peat, beet chip, etc., which have long service intervals. It is desirable, in this regard, for particularly expensive and complex control means to be dispensed with.

### SUBJECT-MATTER OF THE INVENTION

According to the invention, the object is achieved in that at least two fastening elements, which preferably have undercuts, beads and/or corners, are provided on the fastening side opposing the working surface for fastening the ground element in corresponding holes in a support body. These ground elements have the advantage that the fastening elements allow secure fastening to a support body, so even relatively high transverse forces can be absorbed. In particular, the ground elements allow a modular construction of ground discs, so the properties of the individual ground sectors can be coordinated more effectively than in known ground discs comprising permanent mould casting plates.

Continuous holes are preferably provided in the elements, which holes can be used for injecting or draining water. The water produced on pulping of fibres can thus be removed rapidly. The holes are expediently in the form of slots with a diffuser-like outlet.

The proposed, novel ground elements have the advantage that the ground elements can be produced by powder pressing or preferably by powder injection moulding (PIM). This allows the ground elements to be produced cost-effectively. Expediently, the ground elements are surface-compacted (by duplex coating: diffuse ion nitriding+IBAD, ion beam assisted deposit of WC—Co, TiN, DLC, etc.). This allows the production of very durable ground elements having high thermal stability.

According to a preferred embodiment, a first type of ground element is made of materials having high thermal stability. These can include, for example, ground elements made of hard metal and mixed with high-temperature carbides, high-temperature (mixed) carbides, nitrides or borides or mixtures thereof with a cobalt matrix. Preferably, the first type of ground element is made of hard metal comprising WC, TiC, SiC—SiN, optionally also borides or similar hard phase formers with a Ni/Co—Cr—V—Nb—B—Si—C-type eutectic matrix. Ground elements of this type are distinguished by a high thermal stability of greater than 2,000° C., preferably greater than 2,500° C. and particularly preferably greater than 2,800° C.

A second type of ground element, made of ceramic materials, is advantageously provided. This second type can be made of inexpensive materials. A possible composition of the ground element is, for example, Si—Al—Zr oxide. Alternatively, the second type of ground element can be made of pressed carbon fibres, optionally with DLC coating.

The present invention also relates to a ground body comprising ground elements according to the invention, which is characterised in that drilled or punched holes are provided in the support body and in that the ground elements comprising the fastening elements are received in the drilled or punched holes with an interlocking fit. The interlocking fit can be produced in this case by sheathings with materials having a lower melting point than the ground elements and support body or carrier plate respectively. Ground bodies of this type have the advantage that the ground elements can be exchanged rapidly by being heated. The geometry and material properties of the ground bodies composed of individual ground elements can also be optimised. Thermal internal stresses can thus be avoided at the bearing faces. The ground elements comprising the fastening elements can be made, by powder pressing, preferably powder injection moulding (PIM), of materials sintered to high strength. These (individual) ground elements are expediently fastened to perforated carrier plates with an interlocking fit by means of their fastening elements. The ground elements can therefore be exchanged easily and rapidly. The fastening elements arranged in the drilled or punched holes are expediently sheathed with plastics material, bonded or soldered. Sheathing of the fastening elements has the advantage that the fastening elements are secured in the support body.

Advantageously, the first type of ground element is inserted in the support body by co-sintering of the ground element and support body, preferably by two-step pressing of the ground elements and support body in the same press mould (by powder pressing or PIM). It is expedient if the first type of ground element having a compacted surface is inserted on a support body of geometry such that welding/tack-welding to working faces of apparatuses is possible without extending the heat affected zone into the ground element.

Preferably, the fastening elements comprising beads and/or corners are produced by cold pressing and inserted into the holes in the support body with low internal stress. This embodiment has the advantage that the fastening elements can no longer become detached from their fastenings.

A preferred embodiment provides for the provision of ground elements of the first and the second type on the support body. This has the advantage that the differing regions of a ground plate can be provided with differing grinding properties. Preferably, a plurality of ground elements of the same type, adjacent to one another in each case, are combined to form sectors having specific grinding properties or the plurality of ground elements form working edges having identical properties. Advantageously, the ground body has, in the direction of the flow of material, at least two sectors occupied by ground elements of the first or the second type.

Preferably, there are arranged on carrier plates a plurality of individual ground elements, the size of which corresponds to the size of conventional permanent mould casting plates. This has the advantage that the carrier plates comprising the ground elements can be used instead of the conventional permanent mould casting plates. Although the ground elements according to the invention can be arranged directly on a housing wall, for example, of an extruder or on a rotor carrier disc, the use of an additional carrier plate or a carrier body has the advantage that the ground elements can be pre-assembled thereon. The ground elements can also easily be recycled, as the carrier plates comprising the ground elements can be introduced directly into a furnace in order to melt the solder or other materials which have a relatively low melting point and can be used for the detachable fastening of the ground elements on the carrier plate.

According to an independent aspect of the invention, a first sector is occupied by ground elements which ensure “emergency running properties”. The surface of this first sector projects beyond the surfaces of the adjacent sectors preferably by a specific distance. This is based on the idea of raising, in a machine, at least the ground elements of a first sector from the ground elements of a second, preferably adjacent sector, so the first sector forms what is known as a scraping protection means. This can prevent ground elements or entire ground plates, respectively, from being destroyed if they should enter into contact during operation. Because the surface of the (first) ground element having “emergency running properties” is set apart from the other (second) ground elements, there is, in a mill work, a smaller working gap between the first ground element and an opposing face than between the other ground elements and the opposing face. The opposing face can, in this case, also be occupied by ground elements or be formed by a stationary wall with or without a structure (lamellas or the like).

Obviously, in the various uses of the ground elements, for example in extruders, screw-type extruders, on ground plates of refiners, a respective sector of ground elements having high thermal stability is used as the scraping protection means. In other words, in the region of this sector, there is a smaller working gap, so remaining sectors comprising ground elements are protected.

The ground element having emergency running properties (a plurality of identical elements can be combined to form sectors) is preferably made of an abrasion-resistant material which has a fine-grained structure but also residual strength. The ground element of the first type can be made thicker than ground elements of the second type. However, it is also conceivable to cause the first ground elements to be set apart by appropriate configuration of the base (support body). However, it is also conceivable to make the ground element having emergency running properties or sectors formed therefrom from pressed carbon fibres.

According to a preferred embodiment, the other ground elements of the second and third sector can consist of inexpensive ceramic elements. The initially described ground element can, in this case, be the central sector and the surface of the first ground element can be set apart from the surfaces of the two other (second) ground elements. This embodiment is particularly suitable for high-speed refiner paper mills with ground discs comprising annular sectors optimised for the desired operations. Advantageously, the central sector is set apart from the surfaces of the inner and outer sector. The central sector has “emergency running properties” and therefore acts as a scraping protection means which prevents the other sectors from rubbing against one another during operation.

A particularly advantageous embodiment makes provision for the ground body to have a carrier plate on which a plurality of first and/or second ground elements is arranged. This carrier plate can correspond to the size of known one-piece permanent mould casting segments. Compared to conventional ground bodies, this is a completely different design in which the one-piece permanent mould casting segments are divided into a plurality of individual ground elements. This allows completely different production methods to be used for the production of the ground bodies or ground elements respectively, for example powder injection moulding (PIM). This production method allows the fastening members to be directly formed integrally with the ground elements. Advantageously, the individual ground elements have on their back (i.e. opposing the working surface) fastening members which are connectable or connected to the support body with an interlocking fit. The compression-loaded faces can thus still have low internal stress. Possible fastening members include bolts, hollow pins, screws or the like. These ground elements have the advantage that the especially operable outer zone is 100% usable, i.e.—in contrast to conventional ground bodies comprising permanent mould casting plates—there are no longer any screw holes for fastening the ground elements in the working face.

Preferably, the fastening members are dovetailed feet received in holes in the support body, preferably round holes comprising an upwardly conical bore. These have the advantage that they can be sheathed with plastics material—or soldered—in a defined position at low heat and can thus be secured in the support body. The feet can be polygonal in order to allow horizontal stresses to be delimited in the plastics material of the support body material. The support body can, in turn, have precise cylinder hollow pins which can secure the fastening members, for example, in a rotor while at the same time allowing rapid exchange. Also possible, in the case of support bodies which have to protect merely the outer edges of rotors or worms, are integrally formed tabs fastened to the rotor using short, detachable weld seams.

The sectors are expediently covered by a plurality of ground elements which have surface structures well known to a person skilled in the art. For example, in the paper production process, surface structures of the sector parts, for example ribbed geometries comprising channels a few millimetres in depth, are to ensure the pulping of pulp into optimally thin fibres and the discharge of the material. Ground elements of such configuration could also be referred to as lamellar elements or lamellar bodies. Preferably, these lamellar elements of the sectors are produced by powder injection moulding (PIM) or by powder pressing, optionally hot isostatic pressing (HIP).

The use of PIM allows a three-layered composite body to be optimised and mass-produced cost-effectively: merely the layer directly below the coating (TiN, DLC, etc.) is expensive hard metal, sintered as a perfect substrate. The base is formed, for example, by hardenable, ferritic chromium steel (17-4) co-sintered with the hard metal. This has the additional advantage that a composite body of this type can also be connected to a carrier plate by welding.

Producing the sector parts by powder injection moulding or powder pressing has the major advantage that the edges of the surface structures can already be produced in optimum form. Mills comprising ground bodies of this type therefore produce an optimum result from the outset. Conventional ground plates made of permanent mould casting, on the other hand, the surface structures of which initially have sharp edges, have first of all to run in and therefore produce an optimum result only after a specific number of operating hours.

Within the present invention, differing combinations of materials are possible for the individual sectors of ground bodies: if three (annular) sectors are provided, these can be made, in the direction of the flow of material (from inside to outside), for example, of the following materials:

permanent mould casting, hard metal, ceramics or
permanent mould casting, hard metal, carbon fibre part or
ceramics, hard metal, hard metal or
ceramics, hard metal, carbon fibre part or
hard metal, hard metal, carbon fibre part or
permanent mould casting, hard metal, carbon fibre part.

Further combinations are conceivable.

Advantageously, the dovetailed, optionally angular feet received in the holes are sheathed with plastics material or bonded or soldered (or directly co-sintered with liquid phase, see above). This has the advantage that the securing can be carried out with an interlocking fit and very rapidly. The ground elements can be removed by heating the ground bodies. In the case of three-layered composite bodies, the weld connection of the carrier plate can be undone.

Expediently, the ground elements are produced by powder pressing or PIM as lamellar bodies having surface structures.

Advantageously, the outer sectors are configured as carrier plates comprising maraging or age-hardened duplex steels—precisely drilled as a perforated plate segment using a known method. In principle, the carrier plate can also be manufactured as a punched part (FIG. 21c) comprising cold-pressed conical holes. The advantage resides in the beneficial coefficient of expansion and in the substantially higher yield point with sufficient corrosion resistance; sufficient strength can be set. This allows a reduction in weight and hence lower centrifugal forces or higher working speeds.

A carrier plate can be arranged on the rotor, with bores and screw holes for knop feet. Screw holes allow ground or lamellar elements respectively, which can be exchanged without dismantling the rotor, to be received directly.

For monitoring the water content, the stator-side ground bodies can be provided with bores. According to one embodiment, the lamellar bodies (ground elements) can have bores in the knop feet that can allow water to be injected or drained without active surface area being lost (FIG. 18, 19). It is in this case possible to press the holes into a slotted shape without additional costs, and this has procedural advantages. Behind the slot, there can also be pressed-in a diffuser-like opening in the holes that prevents blockages.

The present invention also relates to a mill, in particular a high-speed refiner for paper stock, comprising ground elements according to any one of claims 1 to 31. The carrier plate can be connected to the rotor by cylindrical hollow pins (FIG. 6 to 10) or by a detachable weld connection. Tabs can, in this case, facilitate points for detachable weld connections which prevent a heat affected zone in the region of the knop feet of the elements.

For monitoring the water content, the stator-side ground bodies can be provided with bores. According to one embodiment, the lamellar bodies (ground elements) can have bores in the knop feet that can allow water to be injected or drained without active surface area being lost.

The rotor can be configured as a disc, cone or roller.

The present invention also relates to a mill with ground bodies comprising sectors differing in the radial direction, which is characterised in that an annular sector is made of materials having high thermal stability and which has “emergency running properties”. Advantageously, the width of the gap between the opposing ground elements having emergency running properties is smaller than the width of the gap between the other ground elements. This has the advantage that the sector having emergency running properties prevents the other sectors from rubbing against one another and therefore damaging one another. This results in much longer service lives of the ground plates and also qualitatively improved results for the ground product.

The invention will be described hereinafter in greater detail, by way of example, with reference to the drawings, in which:

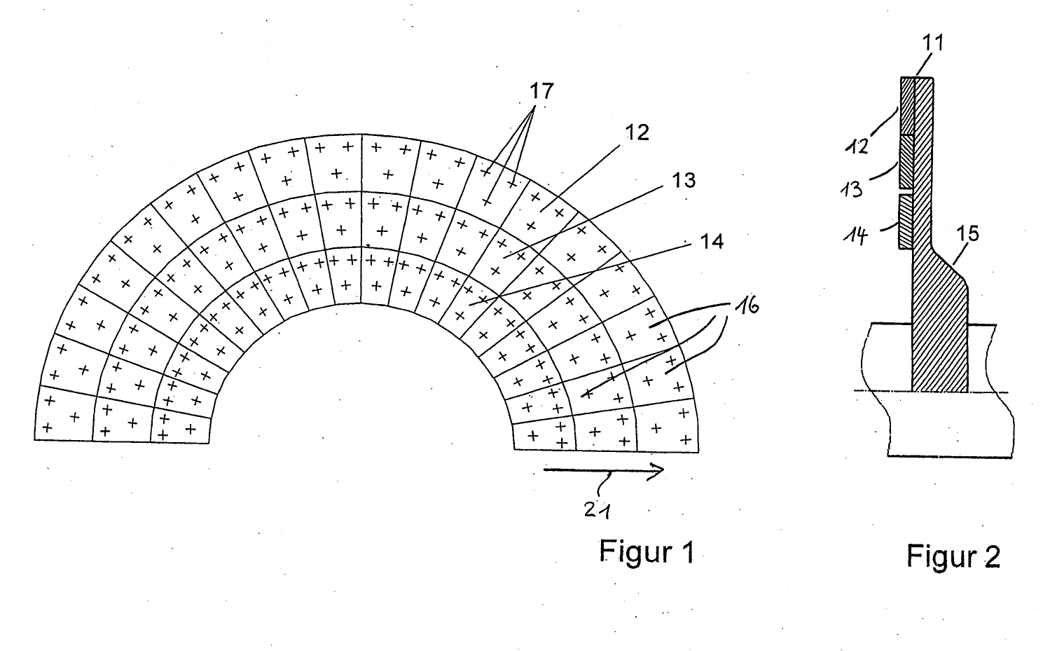

FIG. 1 is a schematic plan view onto a traditional rotor configured as a disc and having conventional ground elements arranged thereon;

FIG. 2 is a longitudinal section of the disc rotor from FIG. 1;

FIG. 3 is a schematic cross section on an enlarged scale of the known rotor from FIG. 2 (prior art);

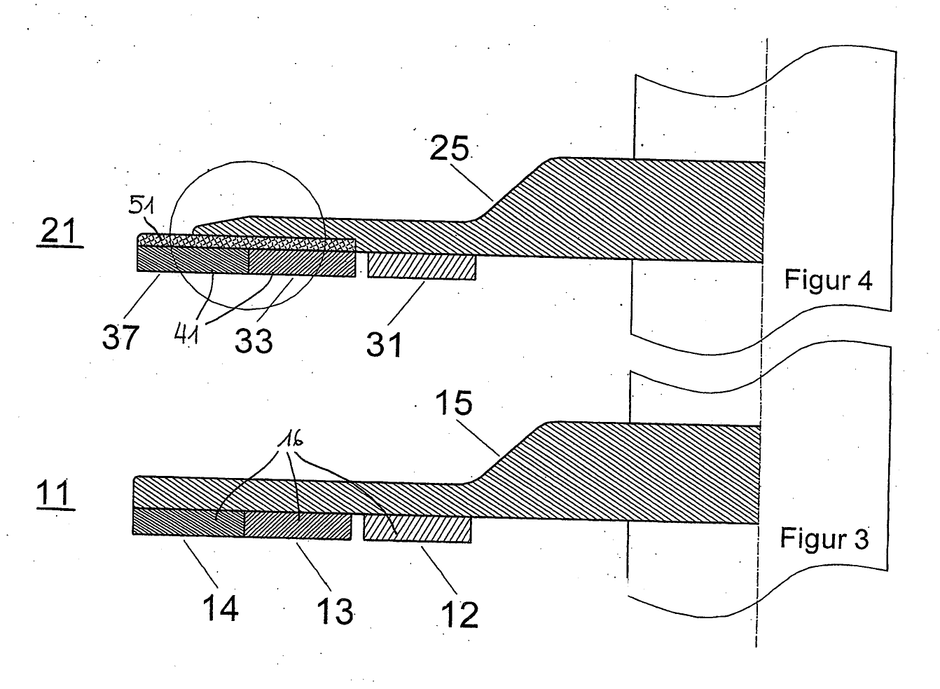

FIG. 4 is a cross section of a first embodiment of a disc rotor comprising a carrier plate and ground elements according to the invention arranged thereon;

FIG. 5 is an enlarged view of a detail of the rotor disc from FIG. 4, comprising a carrier plate for lamellar elements, optionally fastened to the rotor using cylinder hollow pins;

FIG. 6 is a schematic longitudinal section of a ground element which is arranged on a support body, has lamellas and comprises knop feet having undercuts;

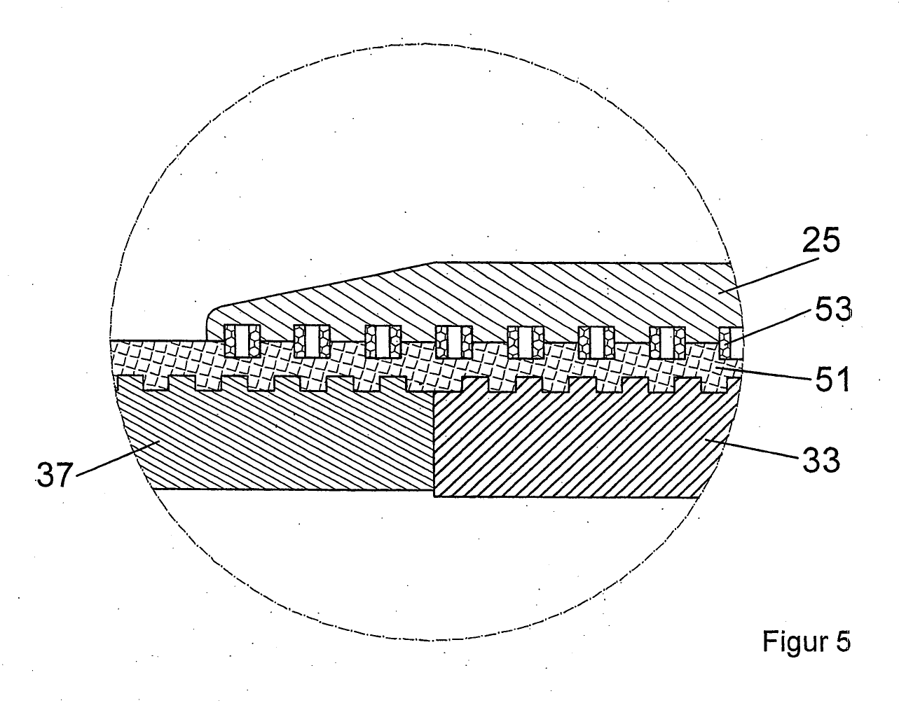

FIG. 7 is a schematic cross section of the ground element of FIG. 6;

FIG. 8 is a plan view of the ground element from FIG. 6;

FIG. 9 shows a second embodiment of a ground element according to the invention comprising (water) apertures;

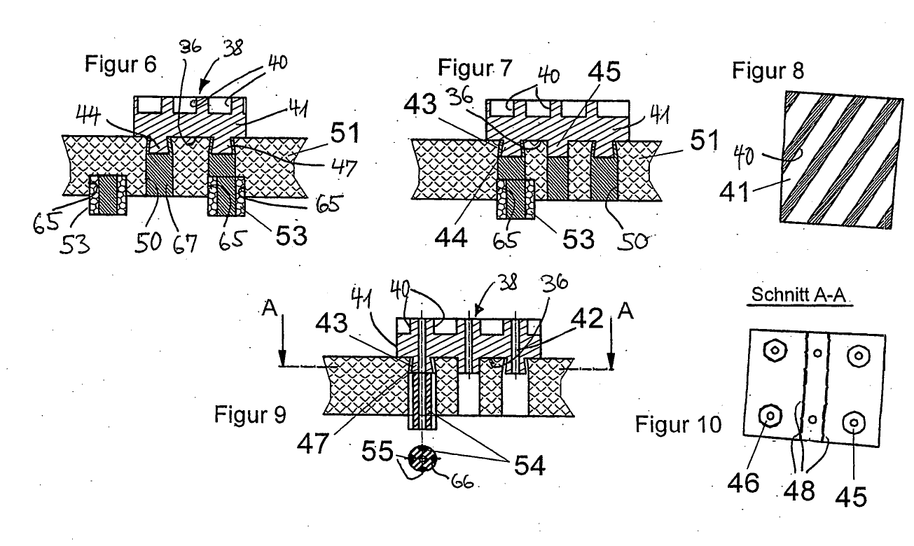

FIG. 10 is a cross section through the ground element from FIG. 9, taken along the line AA;

FIG. 11 shows schematically the arrangement of the ground bodies for any desired mills: a double-flow refiner comprising a housing and a conical rotor;

FIG. 12 is a schematic cross section of a screw-type extruder comprising a rotor (worm) arranged in a cylindrical housing, the helix being configured as a ground body with ground elements arranged on the spiral;

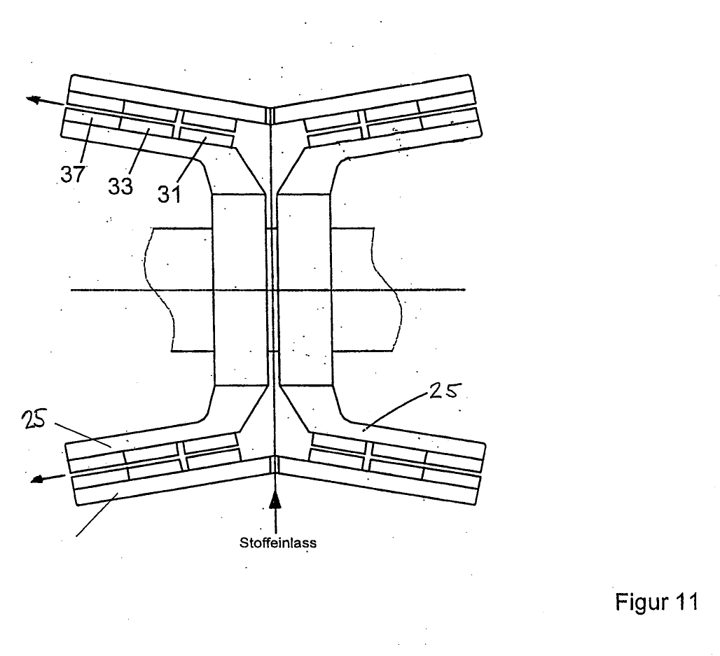

FIG. 13 is a cross section through the screw-type rotor from FIG. 12;

FIG. 14 shows a drainage pressure worm comprising ground elements according to the invention;

FIG. 15 shows a plug screw able to drain water;

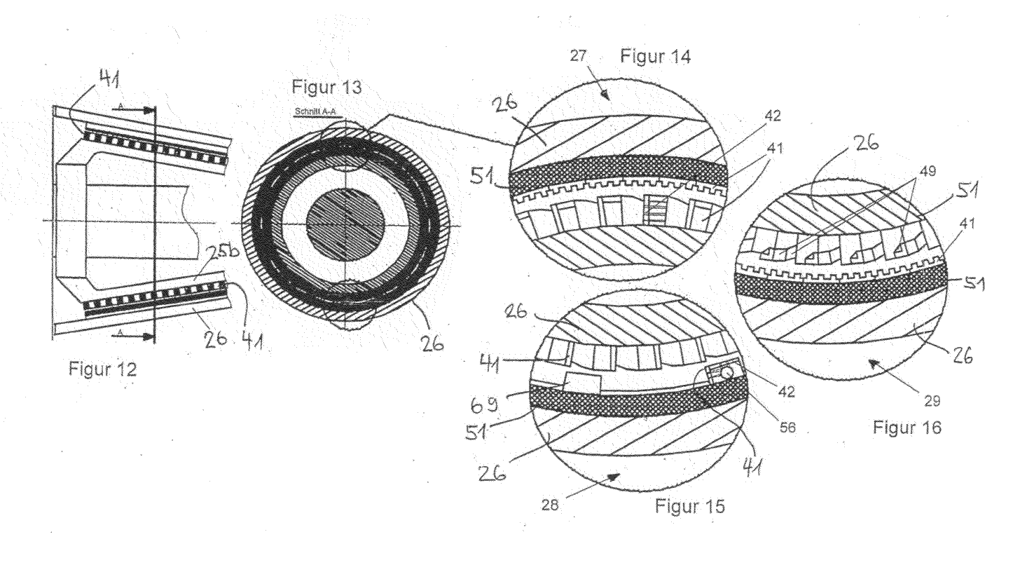

FIG. 16 shows an extruder comprising various ground elements according to the invention;

FIG. 17 is a plan view onto the working face (lamellas) of a ground element according to the invention;

FIG. 18 is a cross section through a ground body comprising a ground element which consists merely of hard metal lamellas and is directly connected to the carrier plate by co-sintering or is embedded therein;

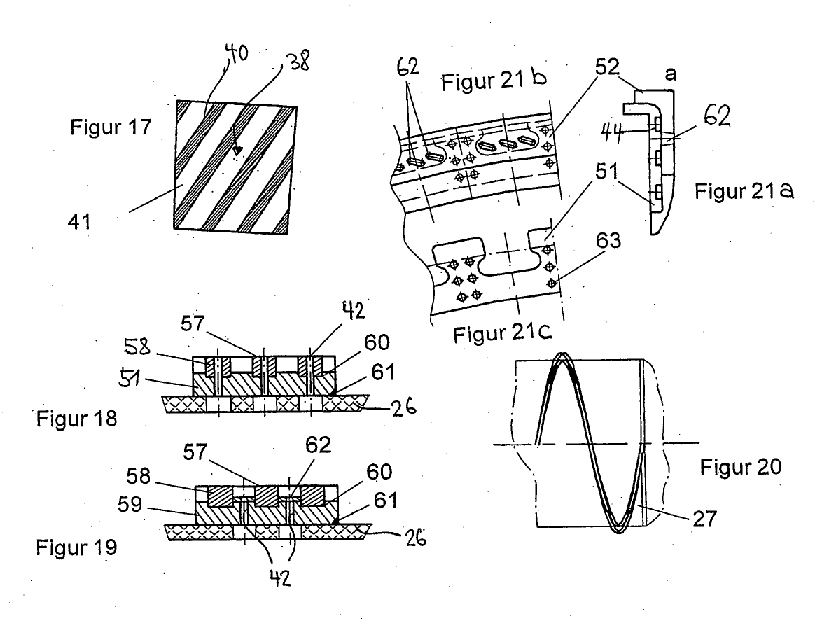

FIG. 19 shows a further embodiment of a ground body comprising a (water) aperture between the lamellas;

FIG. 20 shows an extruder screw-type rotor having a helical thread;

FIG. 21a is a cross section of an embodiment of an extruder element comprising a (water) aperture;

FIG. 21b is a plan view onto the extruder element; and

FIG. 21c is a plan view onto a punched carrier plate.

A known rotor 11 used in a mill work (FIGS. 1 to 3) has an assembly face which is occupied by a large number of permanent mould casting plates 16. The permanent mould casting plates 16 are connected directly to the rotor carrier disc 15 located therebelow using screws or bolts 17. The permanent mould casting plates 16 are arranged in the radial direction (arrow 21) in three annular sectors. The arrangement in annular sectors is necessary because manufacturing the permanent mould casting plates 12, 13, 14 so as to have larger dimensions and with the requisite precision involves high production costs.

The rotor 25 differs from the known rotor in that there are provided annular sectors 31, 33 and 37 consisting, at least in part, of differing materials (not only permanent mould casting metal). A sector which has emergency running properties and projects beyond the other sectors is also provided. In the illustrated embodiment comprising three annular sectors 31, 33, 37, the central annular sector 33 projects, for example, beyond the two other annular sectors 31 and 37 (FIGS. 4 and 5). “Emergency running properties” are thereby imparted to the annular sector 33, as will be described hereinafter in greater detail. Each sector 31, 33, 37 consists of a large number of individual ground elements 41. These ground elements 41 are arranged on a carrier plate 51 which is rigidly connected, for its part, to the rotor carrier disc 25. It is conceivable for the carrier plate to be formed by the rotor carrier disc.

The rotor 25 is arranged at a distance from a stationary ground disc (not shown in the figures) which can be of similar construction to the rotor carrier disc 25, i.e. occupied by identical ground elements.

FIGS. 11 and 12 to 16 show various implementations of the invention. FIG. 11 shows, by way of example, that the ground elements can be used in a conical mill work (the left and right-hand sides of FIG. 11 show conical rotors 25a arranged in a conical ground housing 26 (the apex angle may vary). Ground elements 41 are in this case attached, opposing one another, both to the rotor 25a and to the ground housing wall 26 (=support body). FIG. 12 shows an embodiment having a conical rotor 25b comprising ground elements 41 which have a working face having a lamellar structure or a smooth working face. The ground elements can be provided with apertures 42 (see FIG. 9).

FIGS. 6 to 10 show the form of the individual components and also the mechanical connection thereof. As mentioned hereinbefore, each sector consists of a large number of individual ground elements 41. Each sector can be formed of a plurality of carrier plates on which a plurality of ground elements is in each case arranged. These ground elements 41 are generally smaller than the conventional permanent mould casting plates of known rotors. This means that a conventional permanent mould casting plate is replaced by a plurality of ground elements 41. The ground elements 41 have a working surface 38 incorporating troughs 40, thus producing a lamellar structure. Fastening feet are provided on the fastening side 36 opposing the working face 38. The fastening feet can be configured, in cross section, so as to be dovetailed (foot 44), polygonal (FIG. 10: foot 46) or rectangular comprising beads (FIG. 10). Individual cylindrical feet 45 can be configured without undercuts for precise fixing of the ground elements 41 on the carrier plate 51.

The ground elements 41 are arranged on a carrier plate 51. The carrier plate can be a type of intermediate plate having a perforated structure. The perforated structure consists of a large number of holes 50 (FIGS. 5 and 21) used for receiving the fastening feet 45, 46, 47, 48 of the ground elements 41. Hollow pins 53 are provided on the side of the carrier plate that opposes the ground elements 41 (the underside). The hollow pins 53 are received in cylindrical recesses 65 on the underside of the carrier plate 51. The recesses 65 are preferably distributed uniformly over the underside of the carrier plate 51 and can also overlap with the holes 50 for the knop feet (=fastening elements) or correspond thereto.

The configuration of the fastening feet 44 with an undercut, for example as dovetails, entails the advantage of secure fastening. The polygonal or rectangular configuration with beads (feet 46 and 48 respectively) allows an interlocking press fit by local, plastic flowing of the carrier plate without high internal stresses resulting overall in the element. For rigidly connecting the ground elements 41 on the carrier plate 51, the fastening (knop) feet, having for example an undercut, can be sheathed with plastics material 67, bonded or fixedly cast using a solder (see the description of FIGS. 17 to 19 hereinafter).

The hollow pins 53 are used for fastening the carrier plate 51, for example, on a known rotor disc 15. The hollow pins 53 can be distributed in such a way that they correspond to the model of the fastening holes in conventional rotor discs. This has the advantage that rotors comprising conventional permanent mould casting plates can be equipped with new ground elements according to the invention.

The embodiments shown in FIGS. 4, 5 and 9 are characterised in that drainage channels 42 are provided in the ground elements 41. Hollow pins 54 can be received in the holes 50, thus allowing water to be drained through the hollow pins 54. The drainage channels 42 extend in this case through the fastening feet. This allows a liquid ground product to be drained during the grinding and pulping process. In the illustrated embodiment of FIG. 9, the connection between the ground element 41 and the carrier plate 51 is produced using a solder 55. The solder 55 can be inserted or bonded in grooves 66 in the hollow pin 54 (FIG. 9, view from below of the hollow pin 54). Heating the solder 55 allows it to flow, provided that the ground body is positioned accordingly, into the gap between the dovetailed fastening foot 44 and the conical end part 43 of the hole 50. The end piece, protruding from the bottom of the carrier plate 51, of the hollow pin 54 is able to take over the function of the hollow pin 53 and be used for fastening the ground body, consisting of the ground element and the carrier plate, to a rotor or stator.

In accordance with the further advantageous embodiments illustrated in FIGS. 6 to 10, the fastening feet are configured in such a way that the external diameter thereof corresponds substantially to the internal diameter of the holes. Screws, which are received in bores otherwise used as water apertures, can also be provided for fastening the ground element 41 to the carrier plate 51. These are then cut as a thread and obtained in the form of a water aperture.

FIGS. 12 to 16 show sectors of exemplary rotors. The individual sectors shown correspond in terms of size to conventional ground discs which are formed in one piece. In contrast to conventional ground discs, the sectors of the new type of ground disc are composed of a plurality of individual ground elements 41.

FIG. 14 shows a drainage pressure worm in which the worm 27 and housing wall 26 are occupied by ground elements 41 according to the invention. The ground elements 41 can be equipped with drainage channels 42.

FIG. 15 shows a plug screw, to the housing wall 26 of which anti-rotation strips 69 are attached. The anti-rotation strips are designed in such a way as to be occupied by ground elements 41 comprising drainage channels 42. The drainage channels 42 are connected to a central drainage channel 56. During operation, liquid can be drawn off through the drainage channel 56.

The extruder shown in FIG. 16 is characterised in that ground elements 41 having rectangular feet (only indicated in the figure) are arranged on the extruder screw. The ground elements 41 can be smooth without lamellas. For high pressures, the ground elements overlap in the direction of the flow of material.

FIGS. 17 to 19 show a further embodiment of a ground element 41 according to the invention having lamellas 58 made of hard metal. The lamellas 58 preferably have beads (which cannot be seen in the figure) on their underside. These lamellas 58 are sheathed with a carrier plate 51. The lamellas 58 and the carrier plate 51 are then jointly sintered (co-sintered). The working face of the lamellas 58 is optionally surface-compacted by duplex coating (layer 57). Reference numeral 60 denotes the connecting face between the carrier plate 51 and the lamellas 58. The ground element thus formed can optionally be fastened on a rotor or housing a welding bead 61. This ground body is distinguished by a very compact design in which the ground element and carrier plate are almost in one piece.

The variation of FIG. 19 shows a ground element in which the water aperture 42 is arranged between the lamellas 58. The inlet can be formed by an inserted hard metal plate comprising a diffuser 62 (slotted diffuser).

FIGS. 20 and 21 show an embodiment of the high-pressure part of a pressure worm. The invention will be described hereinafter in greater detail, by way of example, with reference to a high-speed mill work (high-speed refiner) comprising, from inside to outside, three annular sectors 31, 33, 37 (FIGS. 4, 5). The ground bodies are configured in this case as ground plates on an extremely high-speed disc rotor (first extreme case). The disc rotor can be cooled by injection of water.

The other extreme case is a low-speed pressure worm which drains water from moist fibrous material (crude brown coal—40% water content—beet chip, paper fibrous materials and the like); also a pressure worm has an extruder for plastics materials containing glass fibres or rock wool. These examples will be described hereinafter.

The sectors, having differing functions and working gaps, of a high-speed mill work are characterised as follows:

The inner sector 31 is the location at which the still-coarse material (optionally with added ceramics) has to be slowly pulped from the inlet. The working gap can therefore be larger than in the central sector 33.

The circumferential velocity of the inner sector is lower than the circumferential velocity of the central and outer sector. Vapour bubbles and cavitation therefore do not yet have any effect. In the inner sector 31, the coarse material, originating from the inlet and containing ceramic fillers, has to be pulped. With regard to the design of the materials, a permanent (long lasting) form is cast which has high hardness but also still has residual strength (notched bar impact work) can therefore be used for the ground elements. The corrosion resistance can be allowed for in the alloy in such a way that there remains sufficient free chromium for the formation of solid oxide layers at the surface in the metal matrix. High-temperature carbide formers such as V or Nb can be added by alloying for the formation of fine-grained carbide. Even in the case of chromium contents of from 24 to 28% by weight, the matrix will therefore contain sufficient free chromium if the high carbon content is set by special carbides (such as V or Nb, etc). The inner sector 31 is preferably designed in such a way that the removal of oxide is reduced by Tribox (abrasion of the constantly newly formed, insufficiently solid mixed oxides at the surface). The structure, with the fine-grain setting of the carbon by V, Nb or other metals, is characterised in that the matrix is solid and tough and sufficient metallic chromium remains in the matrix to allow the desired notched bar impact work to be achieved. In the regions near the surface, what is known as shot peening can be used to produce internal stresses. These prevent or delay the formation of microcracks. The lamellas of the ground element surface are preferably tough and resistant to fatigue microcracks. The working edges are expediently compacted cold, so as not to be susceptible to cracking. The inner sector can reach up to an adjoining, annular injection zone for “additional water”. The injection of additional water is expedient, as the high internal friction causes the aqueous paper stock partly to evaporate. The systems therefore operate under pressure. Relatively large amounts of water have to be injected if the outer sectors are to obtain water in the form of a wet steam mixture. The lamellar elements have to be made resistant to the inevitable droplet impact (in the resultant wet steam). The processes of wear are intensified—as in pumps and wet steam turbines (cavitation, droplet impact)—by fretting corrosion (Tribox) owing to the ceramic fillers introduced (as in dirty-water pumps).

The central sector 33 of the rotor disc is preferably formed to have high thermal stability. The high thermal stability can be achieved by the integration of securely bound metal carbides. High-temperature carbides endure the incipient formation of vapour bubbles and droplets. The integration of high-temperature carbides such as, for example, WC, TiC, SiC—SiN, optionally also borides or similar hard phase formers into the finest grains makes this sector corrosion and heat-resistant, so partial scraping of this sector does not cause disastrous damage.

For example, powder-pressed ground elements 41 made of Ti-stabilised tungsten carbide in cobalt (conventional use in rock drill bits for mining) form individual sector parts having emergency running properties. These sector parts having a melting temperature of preferably >2,500° C. do not tear or melt on the formation of frictional heat. This sector is accordingly used for the defined distancing.

The considerable transverse forces acting on the ground elements can be absorbed by suitable fastening members, for example knop feet. These knop feet 45, 46, 48 penetrate the bores formed, preferably conically from behind, in the carrier plate 51. The knop feet can be fastened by non-warping low-temperature soldering. Alternatively, sheathing of the knop feet is conceivable. Ground elements of this type, having complex geometry, can be produced cost-effectively and precisely by PIM (powder injection moulding). The various ground elements, which form a sector, can be mass-produced fully automatically on existing plastics material injection moulding machines. All that are required are minor (wear-preventing) modifications to set up the existing machines for the production of the sector parts according to the invention.

The central sector 33 is characterised in that it operates with the smallest working gap and thus, in the event of the rotor discs being scraped, as cannot be entirely avoided, is the first sector to have surface contact. The properties of the hard body allow this scraping in the event of procedural irregularities to be endured briefly, as the temperature of >2,000° C., rapidly produced by friction, can reliably be endured on account of the high melting point of the carbide-containing material (WC, etc.) of >2,800° C. (emergency running properties). The introduction of metal particles caused by wear, in particular the introduction of easily oxidisable iron into the fine paper material, is thus avoided. The properties of lamellar bodies made of pressed carbon fibres—as provided in the outer ring—make the bodies also appear suitable for the central ring, provided that the material to be processed does not place excessively high demands.

The outer sector 37 of the rotor disc comprising the most highly loaded ground elements can be made of much cheaper ceramic lamellar bodies. Shaping is also possible by PIM (Si—Al—Zr oxide). The outer layer 37 can also be made of pressed and sintered ceramic or carbon fibres. For carbon fibres in particular, DLC (diamond-like carbon) can additionally be directionally applied to the working edges (prior art). The ground elements 41 of the outer, annular sector 37 can also be bonded and/or screwed directly to the rotor. The light materials used allow much higher rotational speeds to be achieved, at the same forces, than with conventional ground plates made of a hard metal casting.

One advantage of the modularly constructed ground plates is that the optimum edge geometries, in accordance with the invention, can be pressed without additional costs. For it is possible to determine an optimum working edge geometry for the shape of the ceramic parts and to implement this optimum geometry directly by injection moulding. Optimum operating conditions can thus be achieved for more than 90% of the working time. The service life of the ground plates according to the invention far exceeds that of permanent mould casting ground plates.

The ground elements comprising knop feet can be inserted into holes drilled in the carrier plate and, for example, be sheathed with high-strength plastics material or bonded in a precise position from behind. This can be carried out even at temperatures below 150° C. The central sector rules out the risk of the outer sector being scraped.

The outer sector 37 is characterised in that it contains segments or sector parts that can be exchanged cost-effectively. In this case, too, elements made of pressed carbon fibres, optionally DLC (diamond-like carbon) coated, can be used. The low specific weight allows direct fastening of the sector parts on the rotor plate and thus relatively high rotational speeds at comparatively low centrifugal forces. The elements can optionally be attached directly to the drilled rotor disc.

The outer sector can also consist of carrier plate segments connected to the hub via a grid consisting of short pins. The outer rotor disc (carrier plate 51) can thus be produced like a screen and be easily exchanged.

The outer sector can—as a result of the safe spacing of the rotor discs in the central sector—be formed from ground elements made of ceramic materials which most effectively endure the high-speed droplet impact inevitable in the outer sector and also the frictional wear caused by the fillers. The ceramic ground elements 41 can also be manufactured cost-effectively and precisely by PIM. The material used can be a more favourable ceramic compound, such as for example Si—Al—Zr oxide, than in the central sector. The fastening is produced, as in the other sector parts, preferably by knop feet.

Like the other sectors, the outer sector 37 can also consist of ground elements 41 which can be exchanged cost-effectively. The outer sector of a high-speed refiner accounts for more than 70% of the grinding output. As a result of the optimised material properties and geometry of the outer sector parts, high product quality can be ensured for more than 90% of the operating time. For particularly high rotational speeds and centrifugal forces, ground elements made of pressed carbon fibres, optionally with diamond-like carbon (DLC) coating, can also be used. On account of the low specific weight of the sector parts used, the centrifugal forces are lower, and the rotational speed, and thus the output, can be increased. The light outer ground elements can also be attached directly to the rotor disc. The rotor disc can therefore be very slim and light in its configuration, produced, for example, as a perforated disc or perforated segments.

The advantages of the ground bodies or ground elements according to the invention are: flexible construction of the rotor system in a high-speed mill work (high-speed refiner) and suitability for a broad range of starting materials and end products. Mills comprising the ground elements and ground bodies according to the invention allow an increase in output of up to 20 to 40% with power savings of >20%. The product quality is also higher and more uniform that in mills comprising conventional ground discs. Retrofitting of existing mills is possible in many cases and allows a broad range of services.

### Use of the Ground Elements in Pressure Worms for Crude Brown Coal, Beet Chip or Fibrous Materials:

The ground bodies can be assembled in this case both on the working edges of the worm and on the scraper strips of the housing (FIG. 14). In the ground bodies of the conical, optionally cylindrical housing, there are bores under the ground elements 42 (FIG. 9); these are used in this case for draining water, as the raw material contains from 40 to 60% water and water is to be drained for the subsequent production steps. On boiling or drying, evaporation energy is thus saved. The substance, from which most of the water has been drained, is then pressed out by the mouthpiece and further processed in compact form.

### Use of the Ground Elements in Pressure Screws for Fine Paper Stock: (Drainage Worm for Fine Paper Stock)

The ground elements according to the invention are in this case assembled on the working edges of the worm and over the entire circumference of the housing. The ground elements, which act in this case as working edges for the worms, can be assembled on a punched carrier plate which has lateral outlets for pressed water from the high-pressure region near the outer edge. Between the outlets there are punched extended tabs which can be bent and used for fastening by short, detachable welding beads (see FIGS. 20 and 21). The lamellar form, optimum for each substance, of the surface 38 can substantially promote the flow of materials and ensure, in the crucial region between the working edge of the worm and the grooves in the housing, optimum pressure conditions for drainage. The working gaps remain stable in this case, on account of the hard metal ground bodies, over a long service life. The downtime and modification costs are accordingly reduced. The hitherto conventional configurations have welded-on worm edges and a housing screen made of stainless steel and comprising grooves and drainage bores which round rapidly at the edges. This leads to blockages and downtime.

Pressure Worms (Extruders for Plastics Material (Filled with Glass Stone or Carbon Fibres) But Also for Brickwork or Ore Dressing Slurries and the Like)

The ground elements according to the invention are used in this case to protect both the working edge of the extruder screw and the inner wall of the housing. The ground elements, which can be shaped in any desired manner, are in this case configured for some applications without drainage bores such as 42. For high pressures, the ground elements overlap in the direction of the flow of material, 49. The tolerances are thus to be held in a range which allows manufacture by powder injection moulding (PIM) without reworking. In this case, too, a directional lamellar structure of the surface can entail considerable procedural advantages (service life and guidance of materials).

### LEGEND

11 Rotor (of a refiner)
12, 13, 14 Sectors of traditional ground discs
15 Rotor carrier disc
16 Permanent mould casting plates
17 Screws or bolts
19 Support body
21 Rotor refiner
25 Rotor carrier disc
26 Opposing rotor disc or screw
27 (Pressure) worm
28 Plug screw
29 Extruder
31 Inner sector of the ground bodies
33 Central sector of the ground bodies
36 Fastening side of the ground element
37 Outer sector of the ground bodies
38 Working surface of the ground elements
40 Troughs in the ground elements (lamellas)
41 Lamellar element
42 Water aperture in the ground element
43 Conical bore or pressed cone—punching in the carrier plate
44 Dovetailed foot (with undercut) for sheathing or bonding
45 Cylindrical foot for precise fixing
46 Polygonal foot for delimiting transverse stress peaks
47 Undercut for fixing with solder (at water aperture with cavern pin 54)
48 Rectangularly continuous fixing foot with “beads”—like 46
49 Edge element with rectangular web and beads
50 Holes in the carrier plate
51 Carrier plate
52 Flat lamellar elements with slotted water aperture and bead feet
53 Cylindrical hollow pins for fixing a carrier plate in the rotor carrier disc 25
54 Cavern pin for supplying solder (without blocking of the water aperture)
55 Solder bonded in strips in pin caverns of 54
56 Water apertures
57 (Duplex) coating
58 Lamellas made of hard metal
59 Chromium steel, preferably ferritic or duplex (ferritic-austenitic)
60 Co-sintered (hard metal with beads in 59)
61 Detachable weld connection
62 Water aperture as diffuser
63 Holes punched, with cold pressed shape (like 43)
64 Grooves in the hollow pin 54
65 Cylindrical recesses for pins 53
67 Plastics material (sheathing of the knop feet)
69 Anti-rotation strips

1. Ground element having a smooth working surface (38) or a working surface provided with a lamellar structure, characterised in that at least two fastening elements (44, 45), which preferably have undercuts (44), beads (48) and/or corners, are provided on the fastening side (36) opposing the working surface (38) for fastening the ground element in corresponding holes in a support body (19).

2. Ground element according to claim 1, characterised in that continuous holes or apertures (42) are provided in the elements, which holes or apertures (42) can be used for injecting or draining water.

3. Ground element according to either claim 1 or claim 2, characterised in that the holes are in the form of slots (62) with a diffuser-like outlet.

4. Ground element according to any one of claims 1 to 3, characterised in that the ground elements are produced by powder pressing or preferably by powder injection moulding (PIM).

5. Ground element according to any one of claims 1 to 4, characterised in that the ground elements are surfaced-compacted, for example by duplex coating: diffuse ion nitriding+IBAD, ion beam assisted deposit of WC—Co, TiN, DLC or the like.

6. Ground element according to any one of claims 1 to 5, characterised in that a first type of ground element (41) is made of materials having high thermal stability.

7. Ground element according to claim 6, characterised in that the first type of ground element (41) is made of hard metal comprising high-temperature carbides, high-temperature (mixed) carbides, nitrides or borides or mixtures thereof with a cobalt matrix.

8. Ground element according to either claim 6 or claim 7, characterised in that the first type of ground element (41) is made of hard metal comprising WC, TiC, SiC—SiN, optionally also borides or similar hard phase formers with a Ni/Co—Cr—V—Nb—B—Si—C-type eutectic matrix.

9. Ground element according to any one of claims 1 to 5, characterised in that a second type of ground element (41), made of ceramic materials, is provided.

10. Ground element according to claim 9, characterised in that the second type of ground element (41) is made of Si—Al—Zr oxide.

11. Ground element according to claim 9, characterised in that the second type of ground element (41) is made of pressed carbon fibres, optionally with DLC coating.

12. Ground body comprising ground elements according to any one of claims 1 to 11, characterised in that a support body (19) is provided with drilled or punched holes (50) and in that the ground elements comprising the fastening elements (44, 45) are received in the drilled or punched holes (50) with an interlocking fit.

13. Ground body according to claim 12, characterised in that the fastening elements (44, 45) comprising beads (48) and/or corners are produced by cold pressing and inserted into the holes (50) in the support body (19) with low internal stress.

14. Ground body according to either claim 12 or claim 13, characterised in that the fastening elements (44, 45) arranged in the drilled or punched holes (50) are sheathed with plastics material, bonded or soldered.

15. Ground body according to any one of claims 12 to 14, characterised in that the first type of ground element (41) is inserted in the support body (19) by co-sintering of the ground element and support body (19), preferably by two-step pressing of the ground elements and support body (19) in the same press mould (by powder pressing or PIM).

16. Ground body according to any one of claims 12 to 15, characterised in that the first type of ground element (41) having a compacted surface is inserted on a support body (19) of geometry such that welding/tack-welding to working faces of apparatuses is possible without extending the heat affected zone into the ground element.

17. Ground body according to any one of claims 12 to 16, characterised in that ground elements (41) of the first and the second type are provided on the support body (19).

18. Ground body according to any one of claims 12 to 17, characterised in that a plurality of ground elements (41) of the same type, adjacent to one another in each case, are combined to form sectors having specific grinding properties or form working edges having identical properties.

19. Ground body according to claim 18, characterised in that the ground body has, in the direction of the flow of material, at least two sectors occupied by ground elements (41) of the first or the second type.

20. Ground body according to claim 19, characterised in that the ground body has, in the direction of the flow of material, three sectors (31, 33, 37) which are each equipped with ground elements (41) of the same type and can have the following combinations of materials:
permanent mould casting, hard metal, ceramics or
permanent mould casting, hard metal, hard metal or
ceramics, hard metal, hard metal or
ceramics, hard metal, carbon fibre part or
hard metal, hard metal, carbon fibre part or
permanent mould casting, hard metal, carbon fibre part, etc.

21. Ground body according to any one of claims 12 to 20, characterised in that the working surface (38) of the sector (33) comprising the first type of ground elements projects beyond the surface of the sector (31, 37) comprising ground elements (41) of the second type.

22. Ground body according to any one of claims 12 to 21, characterised in that the ground body has at least three sectors (31, 33, 37) occupied by ground elements, at least one sector being occupied by ground elements of the first type.

23. Ground body according to claim 22, characterised in that the sector comprising ground elements of the first type is the central sector (33).

24. Ground body according to any one of claims 12 to 23, characterised in that the ground elements are lamellar bodies having surface structures (40, 58).

25. Ground body according to any one of claims 12 to 24, characterised in that the support body (19) is made of maraging or age-hardened duplex steels, i.e. ferritic chromium steels having a low specific coefficient of expansion.

26. Ground body according to any one of claims 12 to 25, characterised in that the support body (19) is configured as a ground disc comprising at least three sectors (31, 33, 37) annular in the direction of the flow of material, the central sector (33) preferably being the sector comprising ground elements of the first type and having emergency running properties and projecting beyond the two other sectors (31, 37) by a specific degree.

27. Ground body according to any one of claims 12 to 26, characterised in that the support body (19) has reduced thickness in the outer annular region and is optionally configured as a screen-like carrier plate, with bores (50) for knop feet and/or screw holes.

28. Ground body according to any one of claims 12 to 27, characterised in that the support body (19) is configured as a cone or roller.

29. Mill, in particular a high-speed refiner for paper stock, comprising ground bodies configured as ground discs according to any one of claims 12 to 19.

30. Mill according to claim 29, characterised in that, in the radial direction, at least two sectors are provided with ground elements (41) of the first or second type and at least one annular sector (31, 33, 37) is made of materials having high thermal stability, i.e. has ground elements (41) of the first type, and has “emergency running properties”.

31. Mill according to either claim 29 or claim 30, characterised in that the width of the gap between the opposing ground elements (41) having emergency running properties is smaller than the width of the gap between the other ground elements.

32. Pressure worm comprising ground bodies configured as working edges according to any one of claims 12 to 29.

33. Pressure worm according to claim 32, characterised in that the ground bodies are screwed, soldered or welded to the rotor of the pressure worm.

34. Pressure worm according to either claim 32 or claim 33, characterised in that the housing of the pressure worm has longitudinal strips (69) which are occupied by ground elements (41).

35. Pressure worm according to any one of claims 32 to 34, characterised in that the ground elements (41) have at least one drainage bore (42).

36. Pressure worm according to any one of claims 32 to 35, characterised in that the housing (26) comprising ground elements (41) is configured with a drainage opening (42), so the housing can be suitable for drainage on all sides.

37. Pressure worm according to any one of claims 32 to 36, characterised in that support bodies (19) are provided for the ground elements (41), which support bodies (19) are provided with tabs which are fastened to the rotor of the pressure worm by short, detachable weld seams (55).

38. Pressure worm according to any one of claims 32 to 37 for use as an extruder for plastics materials, plastics materials filled with powders and fibres (PIM), ceramic/organic slurries (brown coal to food) or purely ceramic slurries (for example, brick presses).

39. Ground body comprising a support body (19) and at least two ground elements (41) which are provided on the support body (19) and are arranged one behind the other in a specific direction defined by the direction of conveyance for a ground product, referred to hereinafter as the direction of the flow of material, characterised in that a first ground element (41) is made of materials which ensure “emergency running properties” and in that the working surface (38) of this first ground element projects beyond the surfaces (38) of the other ground element (41) by a specific distance.

40. Ground body according to claim 1, characterised in that the first ground element (41) is made of materials having high thermal stability.

41. Ground body according to either claim 1 or claim 2, characterised in that the first ground element (41) is made of hard metal comprising high-temperature carbides, high-temperature (mixed) carbides, nitrides or borides or mixtures thereof.

42. Ground body according to any one of claims 1 to 3, characterised in that the first ground element (41) is made of hard metal comprising WC, TiC, SiC—SiN, optionally also borides or similar hard-phase formers.

43. Ground body according to any one of claims 1 to 3, characterised in that the first ground element (41) is made of pressed carbon fibres.

44. Ground body according to any one of claims 1 to 5, characterised in that at least one further second ground element (41), made of ceramic materials such as, for example, Si—Al—Zr oxide, is provided.

45. Ground body according to any one of claims 1 to 6, characterised in that the second ground element (41) is made of pressed carbon fibres, optionally with DLC coating.

46. Ground body according to any one of claims 1 to 10, characterised in that a plurality of identical ground elements arranged adjacently to one another are combined, in each case, to form sectors (31, 33, 37) having specific grinding properties and the ground body has a plurality of sectors (31, 33, 37) having respectively similar ground elements, i.e. of the first or second type.

47. Ground body according to any one of claims 1 to 9, characterised in that the ground body has a support body (19) on which the first and second ground elements are arranged.

48. Ground body according to claim 11, characterised in that the individual ground elements (41) have on their back (36) fastening members (44, 45) which are rigidly connectable or connected to the support body (19).

49. Ground body according to either claim 11 or claim 12, characterised in that the fastening members are feet comprising undercuts (44) that are received in the holes (50) provided for this purpose in the support body, preferably in round holes having an upwardly conical bore (43).

50. Ground body according to claim 13, characterised in that the dovetailed feet (41) received in the holes (50) are sheathed with plastics material.

51. Ground body according to any one of claims 11 to 14, characterised in that the ground elements (41) are lamellar bodies having surface structures (40, 58).

52. Ground body according to any one of claims 11 to 15, characterised in that the ground elements (41) are produced by powder injection moulding (PIM) or by hot isostatic pressing (HIP).

53. Ground body according to any one of claims 1 to 16, characterised in that the ground body has, in the direction of the flow of material, at least two sectors made of differing materials.

54. Ground body according to any one of claims 1 to 17, characterised in that the ground elements are configured as perforated plate segments comprising maraging or age-hardened duplex steels.

55. Ground body according to any one of claims 1 to 18, characterised in that the support body (19) is configured as a ground disc (25) comprising sectors (31, 33, 37) annular in the radial direction.

56. Ground body according to claim 19, characterised in that the ground disc has, in the radial direction, at least three annular sectors (31, 33, 37), the central sector preferably being the first sector having emergency running properties and projecting beyond the two other sectors by a specific degree.

57. Ground body according to claim 8, characterised in that the first ground element (41) is the central sector and the surface (38) of the first ground element (41) is set apart from the surfaces (38) of the two other (second) ground elements.

58. Ground body according to claim 19, characterised in that the support body (19) has reduced thickness in the outer annular region and is optionally configured as a screen-like carrier plate, with bores for knop feet and/or screw holes.

59. Ground body according to any one of claims 1 to 18, characterised in that the support body (19) is configured as a cone or roller
